(19) United States
(12) Patent Application Publication
(10) Pub. No.: US 2002/0129629 A1
(43) Pub. Date: Sep. 19, 2002

(54) Suit hanger lock

(76) Inventor: Austin Su, Taipei (TW)

Correspondence Address: Eric K. Satermo, Registered Patent Agent, P.O. Box 19099, Irvine, CA, 92623-9099, US

(21) Appl. No.: 09/809,159

(22) Filed: Mar. 15, 2001

(51) Int. Cl. E05B 69/00

(52) U.S. Cl. 70/59

(57) ABSTRACT

A suit hanger lock comprises a suit hanger and a lock securely mounted to the suit hanger. The lock includes a main body with a lock core therein, the main body further having a receptacle. A cable has a first end securely attached to the main body and a second end that is engaged in the receptacle of the main body when the lock is in a locked state and that is disengaged from the receptacle of the main body when the lock is in an unlocked state.

### BACKGROUND OF THE INVENTION

1. Field of the Invention

The present invention relates to a suit hanger lock for locking a suit on a hanger.

2. Description of the Related Art

A suit hanger is used to prevent generation of creases of clothes. A rack is used in a counter or lobby of a public place for temporary storage of the heavy outerwear (such as overcoats or furs) of the guests to avoid inconvenience to actions. However, one might wrongly take a similar outwear of others from the rack, and it is embarrassing and inconvenient to return the wrong one and retrieve the right one. Suits are generally open to the customers in shops, and this gives thieves a chance when the salesman is not aware. Thus, it is a long and unfulfilled need in a lock for a suit hanger that may lock the suit on the suit hanger so as to prevent loss and/or wrong taking of the suits.

### SUMMARY OF THE INVENTION

A suit hanger lock in accordance with the present invention comprises a suit hanger and a lock securely mounted to the suit hanger. A cable has a first end securely attached to the lock, the cable having a second end releasably engaged with the lock. The suit hanger includes a frame and a ring on top of the frame.

In a preferred embodiment of the invention, a suit hanger lock comprises a suit hanger and a lock securely mounted to the suit hanger. The lock includes a main body with a lock core therein, the main body further having a receptacle. A cable has a first end securely attached to the main body and a second end that is engaged in the receptacle of the main body when the lock is in a locked state and that is disengaged from the receptacle of the main body when the lock is in an unlocked state. The suit hanger includes a frame, a neck on top of the frame, and a hook extending from the neck. Alternatively, the suit hanger includes a frame, a neck on top of the frame, and a ring extending from the frame. The frame includes a bottom having an extension to which the main body of the lock is securely attached.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a suit hanger lock in accordance with the present invention.

FIG. 2 is an elevational view of the suit hanger lock in accordance with the present invention.

FIG. 3 is a sectional view taken along line 3-3 in FIG. 2.

FIG. 4 is a sectional view similar to FIG. 3, wherein the suit hanger lock is unlocked.

FIG. 5 is a perspective view illustrating use of the suit hanger lock.

FIG. 6 is a schematic view illustrating hanging of the suit hangers onto a hanger rod.

### DETAILED DESCRIPTION OF THE PREFERRED EMBODIMENT

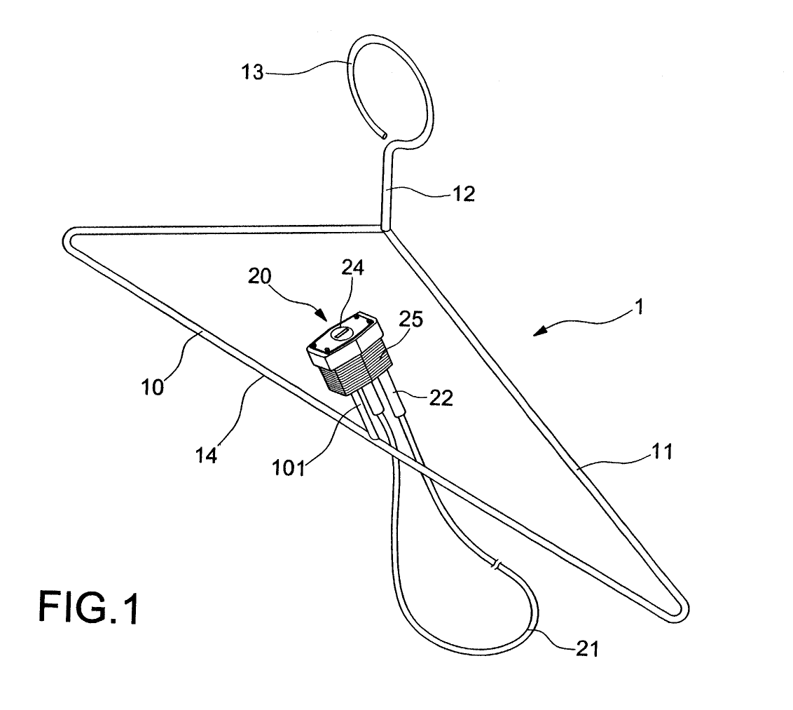

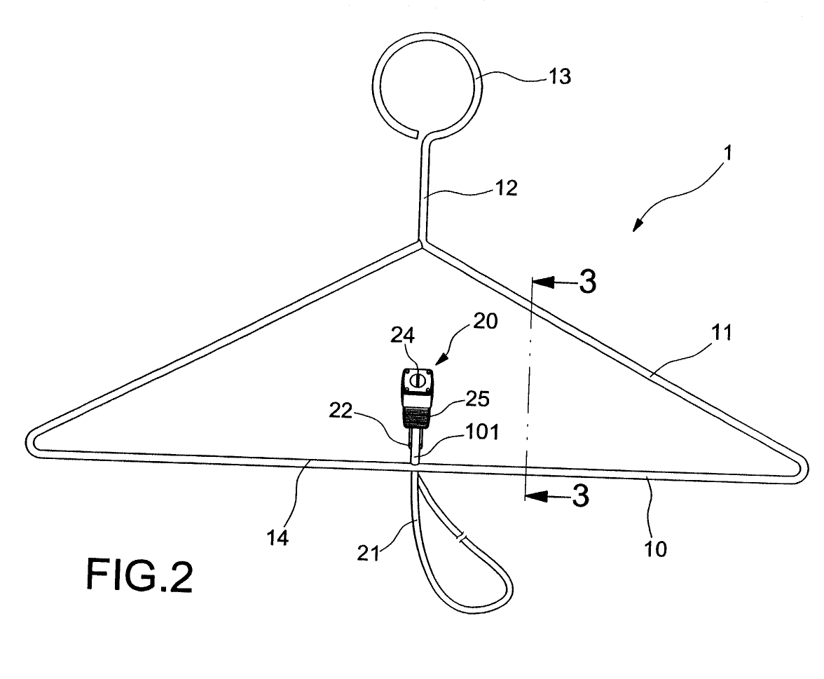

Referring to FIGS. 1 and 2, a suit hanger lock in accordance with the present invention generally includes a suit hanger 1 and a lock 20 mounted to a frame 10 of the suit hanger 1. The frame 10 of the suit hanger 1 is substantially triangular and includes two shoulder sections 11 and a bottom 14. The suit hanger 1 further includes a neck 12 on top of the frame 10 and a ring 13 extended from the neck 12. Alternatively, the ring 13 can be replaced by a hook.

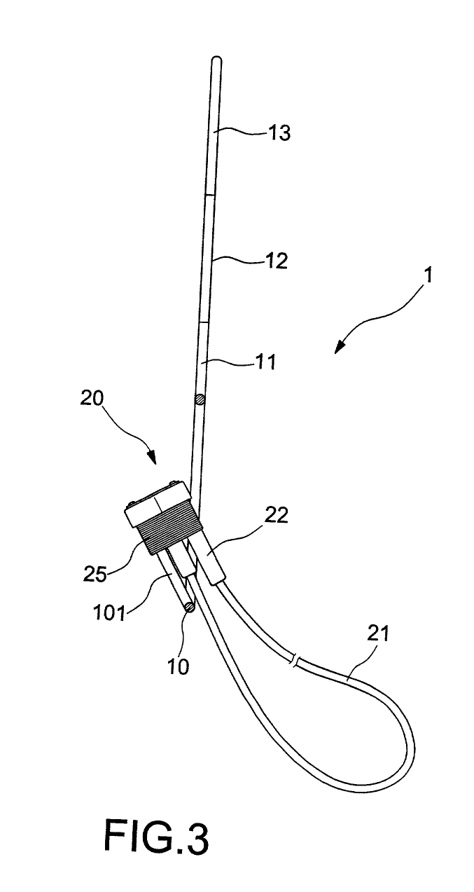

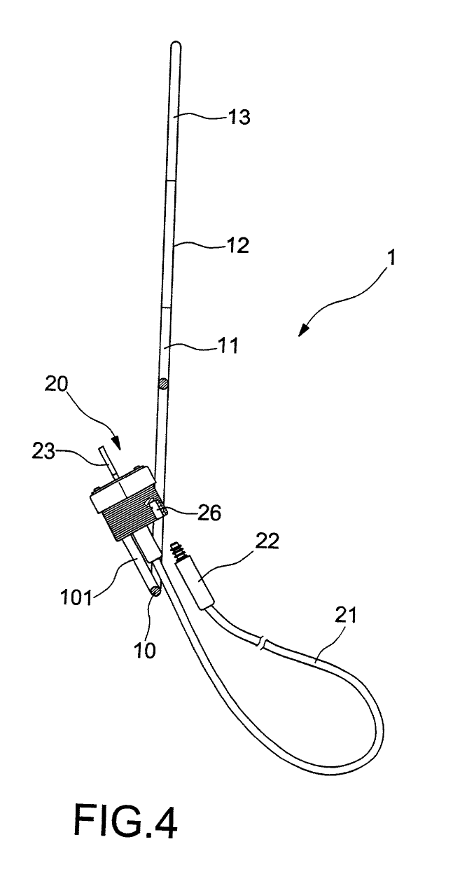

Referring to FIGS. 1 through 3, the lock 20 is securely attached to an extension 101 extending from the bottom 14 of the frame 10. The lock 20 includes a main body 25 with a lock core 24 therein. A cable 21 includes a first end securely attached to the main body 25 and a second end with a locking rod 22 formed thereon. The locking rod 22 is releasably received in a receptacle 26 (FIG. 4) of the main body 25.

Referring to FIG. 4, when a key 23 is inserted into a keyway (not labeled) of the lock core 24 and turned, the lock 20 is unlocked and the locking rod 22 can be removed out of the receptacle 26 of the main body 25.

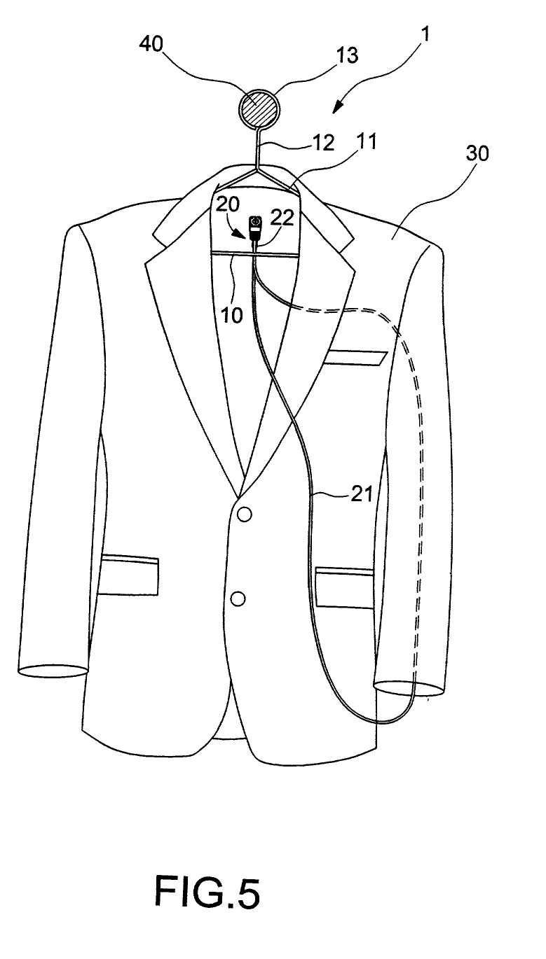

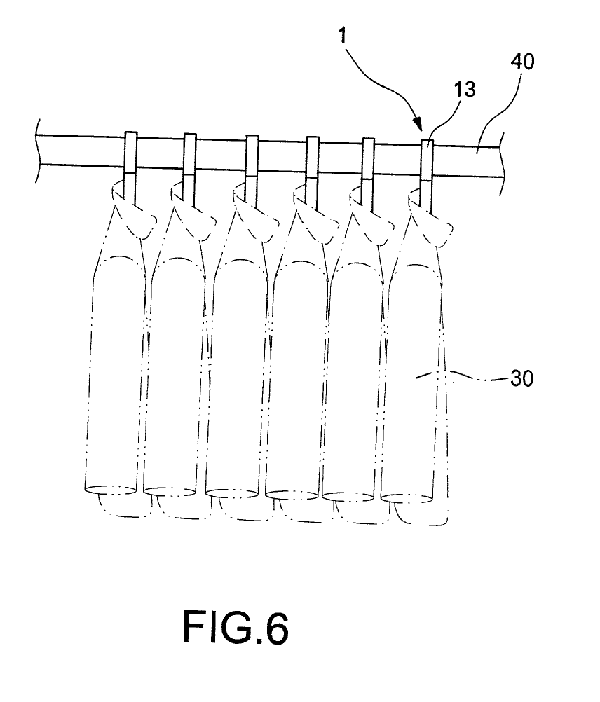

In use, the ring 13 of each suit hanger 1 is extended through by a hanger rod 40 such that the suit hangers 1 cannot be removed from the hanger rod 40 (FIG. 6). Referring to FIG. 5, the cable 20 is extended downwardly through one of the sleeves of a suit (such as a coat) that is hung on the suit hanger 1 with the locking rod 22 on the second end of the cable 20 inserting into the receptacle 26 of the main body 25 of the lock 20. Thus, the lock 20 is in a locked state, and the suit is locked in place. The owner of the suit takes the key with him/her, or a number card or the like is given to the owner of the suit for identification for retrieval. Thus, wrong taking of suits is prevented. Namely, only the owner or the suit keeper may open the suit hanger lock. It is noted that the suit hanger lock in accordance with the present invention can also be used in suit shops to prevent theft. It is further noted that the prevent invention is not limited to the lock 20 illustrated and described. Any other suitable locks can be used without affecting the function.

Although the invention has been explained in relation to its preferred embodiment, it is to be understood that many other possible modifications and variations can be made without departing from the scope of the invention as hereinafter claimed.

What is claimed is:

1. A suit hanger lock comprising:
a suit hanger; and
a lock securely mounted to the suit hanger, a cable having a first end securely attached to the lock, the cable having a second end releasably engaged with the lock.

2. The suit hanger lock as claimed in claim 1, wherein the suit hanger includes a frame and a ring on top of the frame.

3. A suit hanger lock comprising:
a suit hanger; and
a lock securely mounted to the suit hanger, the lock including a main body with a lock core therein, the main body further having a receptacle, a cable having a first end securely attached to the main body and a second end that is engaged in the receptacle of the main body when the lock is in a locked state and that is disengaged from the receptacle of the main body when the lock is in an unlocked state.

4. The suit hanger as claimed in claim 3, wherein the suit hanger includes a frame, a neck on top of the frame, and a hook extending from the neck.

5. The suit hanger as claimed in claim 4, wherein the suit hanger includes a frame, a neck on top of the frame, and a ring extending from the frame.

6. The suit hanger as claimed in claim 5, wherein the frame includes a bottom having an extension to which the main body of the lock is securely attached.
